(19) United States
(12) Patent Application Publication
(10) Pub. No.: US 2026/0218681 A1
(43) Pub. Date: Jul. 30, 2026

(54) METHOD FOR OPERATING A WIND TURBINE, CONTROL SYSTEM FOR OPERATING A WIND TURBINE AND WIND TURBINE

(71) Applicants: Nordex Energy SE & Co. KG, Hamburg (DE); Nordex Energy Spain S.A.U., Barásoain (Navarra) (ES)

(72) Inventors: Alberto Garcia Barace, Pamplona-Irunea (ES); Edurne Miranda Suescun, Mutilva (ES); Edwin van Solingen, Norderstedt (DE); Gritt Pokriefke, Rostock (DE); Jacob Laborenz, Hannover (DE); Varun Jois, Bremen (DE)

(21) Appl. No.: 19/144,845

(22) PCT Filed: Dec. 11, 2023
(86) PCT No.: PCT/EP2023/085061

§ 371 Date: Jun. 30, 2025

(30) Foreign Application Priority Data
Dec. 30, 2022 (EP) 22383319.5

(51) Int. Cl. F03D 7/02

(52) U.S. Cl. CPC F03D 7/0224; F03D 7/0298; F05B 2260/96; F05B 2270/331; F05B 2270/334

(57) ABSTRACT

A method is for operating a wind turbine having a rotor with N rotor blades, wherein N≥2. The wind turbine further includes a pitch setting system for individually setting the pitch angles of the rotor blades. The method includes a step in which first information is determined, wherein the first information is representative for whether an edge-wise movement of at least one rotor blade exceeds a threshold while the rotor is rotating with a frequency P. If this is the case, an output signal is generated which is configured to cause the pitch setting system to individually and periodically change the pitch angles of the N rotor blades each with a frequency of (M*N−1)*P in order to reduce edge-wise movements of the rotor blades, wherein M is an integer greater than zero.

### CROSS-REFERENCE TO RELATED APPLICATIONS

This application is a continuation application of international patent application PCT/EP2023/085061, filed Dec. 11, 2023, designating the United States and claiming priority from European application 22383319.5, filed Dec. 30, 2022, and the entire content of both applications is incorporated herein by reference.

### TECHNICAL FIELD

The present disclosure relates to a method for operating a wind turbine. Furthermore, the present disclosure relates to a computer program, a computer-readable data carrier and a control device for performing the method for operating a wind turbine. Moreover, the present disclosure relates to a control system for operating a wind turbine and a wind turbine.

### BACKGROUND

Wind turbines are widely known and are used to convert wind energy into electrical energy. The lengths of the rotor blades used in such wind turbines have increased in recent years. Vibrations of the rotor blades induce load on the rotor shaft and bear the risk of structural damage of the rotor blades.

### SUMMARY

It is an object of the disclosure to provide a method for operating a wind turbine with which vibrations of the rotor blades of the wind turbine can be reduced, particularly without unnecessarily reducing the power output of the wind turbine. Further objects to be achieved are to provide a computer program, a computer-readable data carrier and a control device for performing such a method. Additional objects to be achieved are to provide a control system for operating a wind turbine with such a method and a wind turbine which is operable with such a method.

First, the method for operating a wind turbine is specified.

According to an embodiment, the method is for operating a wind turbine having a rotor with N rotor blades, wherein N≥2. The wind turbine further includes a pitch setting system for individually setting the pitch angles of the N rotor blades. The method includes a step in which first information is determined, wherein the first information is representative for whether an edge-wise movement of at least one rotor blade exceeds a threshold while the rotor is rotating with a frequency P. If this is the case, that is, if the first information is representative for the edge-wise movement of at least one rotor blade, that is, one or more rotor blades, to exceed the threshold, an output signal is generated which is configured to cause the pitch setting system to individually and periodically change the pitch angles of the N rotor blades each with a frequency of (M*N−1)*P in order to reduce edge-wise movements of the rotor blades. M is an integer greater than zero.

The present disclosure is, inter alia, based on the recognition that an edge-wise movement of a rotor blade can cause high loads on the rotor shaft and can also lead to structural damage to the rotor blade. In the case of very large edge-wise movements of the rotor blade, a wind turbine is normally stopped (turbine stop) but this reduces the annular energy production (AEP). In order to reduce the AEP loss, the inventors developed the so-called individual-pitch-control-(M*N−1)*P, IPC-(M*N−1)*P for short, which, when activated, causes an individual and periodic change of the pitch angles of the rotor blades each with the frequency (M*N−1)*P. This efficiently counteracts the excitation of edge-wise vibrations of the rotor blades so that a shutdown can be avoided.

The method specified herein is, in particular, a computer implemented method, that is, is performed by a computer or a processor.

Herein, when information is representative for a certain quantity or certain quantities, this means that the quantity or quantities can be extracted from the information, either directly, or the quantity/quantities can at least be derived from the information. In other words, the quantity/quantities is/are stored in the information, or at least data are stored in the information, from which the quantity/quantities can be derived or determined or calculated, respectively. Furthermore, here and in the following, information is, in particular, electronic information, like electronic data.

The first information is representative for whether an edge-wise movement, for example an edge-wise vibration, of at least one rotor blade exceeds a threshold while the rotor is rotating with frequency P. The threshold may be a predetermined threshold. By way of example, the first information is either 0 or 1, with 0 meaning that the threshold is not exceeded and 1 meaning that the threshold is exceeded.

The first information may be determined repeatedly, for example, periodically. For example, the first information is determined at least once or at least 5-times or at least 10-times per full rotation of the rotor.

The first information is, in particular, representative for the current situation in the wind turbine. For example, the first information is determined from measurements. The measurements used for determining the first information were taken, for example, at most 5 s or at most 1 s before determining the first information.

The first information may additionally be representative for the number of rotor blades where the respective edge-wise movement exceeds the threshold. The thresholds for the different rotor blades may be the same. For example, only if the first information is representative for the edge-wise movements of two or more rotor blades to exceed the respective threshold, is the output signal generated. That is, the condition that the first information must be representative for the edge-wise movement of at least one rotor blade to exceed the threshold is a necessary condition for the output signal to be generated. It may or may not be a sufficient condition.

The edge-wise movement of a rotor blade is a movement in a reference frame which rotates together with the rotor blade, herein called “rotating reference frame”. Thus, the speed of rotation of the rotating reference frame is the same as the speed of rotation of the rotor blade(s).

The output signal is generated if, particularly only if, the first information is representative for the edge-wise movement of at least one rotor blade to exceed the threshold. The output signal is, in particular, an electric signal which can be transmitted via a wire or wirelessly. The output signal is configured to cause the pitch setting system to individually and periodically change the pitch angles of the N rotor blades each with a frequency of (M*N−1)*P. That is, the output signal includes information which can be evaluated by the pitch setting system and can be translated by the pitch setting system into a mechanical movement of the rotor blades about their longitudinal axes. The pitch angles of all rotor blades are changed with the same frequency and optionally also with the same amplitude. There may be a phase shift in the periodic change of the pitch angles between two rotor blades. For example, the phase shift between two adjacent rotor blades is 2π/N.

For example, the amplitude of the periodic change of the pitch angle of each rotor blade is at least 1° or at least 2° or at least 3°. The pitch angle of a rotor blade is defined, for example, as the angle between the chord line of the rotor blade and the plane of rotation of the rotor (rotor plane). In the case of a pitch angle of 0°, an edge-wise moment of the rotor blade is a movement parallel to the rotor plane.

The generation of the output signal and, optionally, also the start of the periodic change of the pitch angles may be done in real time. For example, it is done/started within a time interval of at most one rotation or at most two rotations of the rotor after the first information has been determined to be representative for the edge-wise movement of at least one rotor blade to exceed the threshold.

After the output signal has been generated and/or the periodic change of the pitch angles has been started, the periodic change is maintained for a certain time interval, for example, for at least one rotation or at least two rotations or at least five rotations of the rotor. During this time interval, it may be continued to determine the first information. In the case that the then-determined first information is representative for the edge-wise movements of less rotor blades or no rotor blades to exceed the threshold, the individual and periodic change of the pitch angles may be stopped. For example, in this case, a further output signal is then generated which is configured to cause the pitch setting system to go back to normal operation. In normal operation, the pitch angles of all rotor blades are the same and/or are changed collectively, for example.

In today's wind turbines, the Eigen-frequencies of the edge-wise vibrations of the rotor blades are sometimes close or even identical to the frequency (M*N+1)*P when the rotor is rotating at its nominal speed or its nominal frequency, respectively. As a consequence, in the case that the rotor is rotating with the nominal frequency, there is a high risk of the local turbulences or a local gust or a sheer in the wind speed resonantly exciting edge-wise vibrations of the rotor blades.

According to a further embodiment, the method includes a step in which second information is provided. The second information is representative for a M*N*P-content in a bending moment acting on the rotor while the rotor is rotating with frequency P. The M*N*P-content is the content in the bending moment of the rotor having the frequency M*N*P.

Bending moments acting on a rotor are quantities investigated in a fixed reference frame. The fixed reference frame is a reference frame of the wind turbine, that is, a reference frame which is not rotating with the rotor. The fixed reference frame is, for example, fixed with respect to the ground on which the wind turbine is mounted. The fixed reference frame is assigned to parts of the wind turbine which are not rotating, for example, the tower or nacelle.

The second information may be representative for the tilt bending moment and/or the yaw bending moment acting on the rotor. The tilt bending moment is the bending moment acting on the rotor in order to deflect the rotor plane around an axis running parallel to the ground and parallel to the rotor plane. The yaw bending moment is the moment acting on the rotor in order to deflect the rotor plane around an axis running perpendicularly to the ground and parallel to the rotor plane.

According to a further embodiment, the first information is determined depending on the second information.

The M*N*P-content in the bending moment acting on the rotor is highly related to the (M*N+1)*P-content in the edge-wise movement of the rotor blade, which results from the rules of transformation between a fixed reference frame and a rotating reference frame. However, it may be easier to determine the bending moments acting on the rotor or it may be easier to control the pitch angles of the rotor blades depending on information about the bending moments acting on the rotor. Therefore, it may be easier to perform the IPC-(M*N−1)*P based on information about the bending moments acting on the rotor instead of directly using information about the edge-wise movements of the rotor blades.

According to a further embodiment, N=3, that is, the rotor includes exactly three rotor blades.

According to a further embodiment, M=1. M=1 relates to the first Eigen-frequency when the rotor is rotating with nominal frequency. The first Eigen-frequency is excited more easily than higher order frequencies and, therefore, an excitation of the first Eigen-mode of the edge-wise vibration bears a particularly high risk of damage.

According to a further embodiment, the method includes a further step in which third information is provided. The third information is representative for bending moments acting on the rotor blades. The bending moments acting on the rotor blades are quantities in the rotating reference frame.

The third information may be representative for the edge-wise bending moment and/or the flap-wise bending moment acting on each rotor blade. Edge-wise and flap-wise bending moments are bending moments which are measurable with the help of sensors, for example, strain sensors. The third information may be representative for the bending moments as a function of time. For example, measurements of the bending moment(s) are taken several times per rotation of the rotor.

According to a further embodiment, the first information is determined depending on the third information.

According to a further embodiment, the method includes a further step, in which fourth information is provided which is representative for a bending moment acting on the rotor as a function of time. The bending moment acting on the rotor may be the tilt bending moment and/or the yaw bending moment.

According to a further embodiment, the second information is determined depending on the fourth information with the help of a filter, for example, a band-pass filter and/or a notch filter. That is, the M*N*P-content in the bending moment acting on the rotor may be determined from the time-dependent bending moments acting on the rotor by applying a filter.

According to a further embodiment, the fourth information is determined depending on the third information with the help of a coordinate transformation. Thus, the bending moment(s) acting on the rotor are determined from the bending moments acting on the rotor blades using a coordinate transformation. The coordinate transformation is, for example, a Coleman transformation.

According to a further embodiment, determining the first information includes or consists of determining whether the amplitude of the M*N*P-content in the bending moment acting on the rotor exceeds a threshold. For example, only when the amplitude of the M*N*P-content exceeds the threshold, is the first information determined to be representative for the edge-wise movement of at least one rotor blade to exceed the threshold.

According to a further embodiment, the third information is representative for the respective edge-wise bending moment acting on the rotor blades. That is, for each rotor blade, the third information is representative for the edge-wise bending moment of that rotor blade.

According to a further embodiment, the first information is determined depending on the third information and includes or consists of determining whether the amplitude of an edge-wise bending moment acting on at least one rotor blade exceeds a threshold. That is, it is determined whether the amplitude, for example, the maximum value, of the edge-wise bending moment of one rotor blade, or whether the amplitudes of the edge-wise bending moments of two or more rotor blades, exceed the threshold(s). If this is the case, the first information is determined to be representative for the edge-wise movement of one or more rotor blades to exceed the threshold.

According to a further embodiment, determining the first information includes or consists of determining whether a (M*N+1)*P-content in the edge-wise bending moment acting on a rotor blade exceeds a threshold. The (M*N+1)*P-content is the content in the edge-wise bending movement having the frequency (M*N+1)*P. For example, determining the first information includes or consists of determining whether the amplitude of the (M*N+1)*P-content exceeds a threshold.

In order to filter out the (M*N+1)*P-content in the edge-wise bending moment, a filter, like a band-pass filter and/or a notch filter, may be used. The filter widths of the band-pass filter may be, for example, between 20% and 50% of (M*N+1)*P.

According to a further embodiment, determining the first information includes determining whether the frequency P lies within a critical frequency range and/or whether the power output of the wind turbine lies within a critical power range. The critical frequency range is, for example, a frequency range including the frequency P with which the rotor rotates in nominal operation (nominal frequency). As explained above, when rotating with the nominal frequency, there is a particularly high coupling to the (first) Eigen-frequency of the edge-wise vibrations of the rotor blades. The critical power output range is equivalent to the critical frequency range.

The first information may be determined depending on several pieces of information, for example depending on whether an amplitude of the M*N*P-content in the bending moment acting on the rotor exceeds a threshold and/or depending on whether an amplitude of an edge-wise bending moment acting on a rotor blade exceeds a threshold and/or depending on whether the frequency P lies with the critical frequency range and/or whether the power output of the wind turbine lies within a critical power range. For example, only when at least two of these conditions are fulfilled, is the first information determined to be representative for the edge-wise movement of at least one rotor blade to exceed the threshold. For example, only when the M*N*P-content in a bending moment acting on the rotor and at least one of the other conditions are fulfilled, is the first information determined to be representative for the edge-wise movement of at least one rotor blade to exceed the threshold.

According to a further embodiment, the third information is determined depending on measurements taken with the help of a sensor system. The sensor system is, for example, part of the wind turbine. The sensor system may include one or more strain sensors, for example, optical fiber sensors or strain gauge sensors. Moreover, the sensor system may include a position sensor for measuring the position(s) of the rotor blades. Particularly, the sensor system is configured to measure the edge-wise and/or flap wise bending moments of the rotor blades. The positions of the rotor blades are, for example, their azimuthal angles in rotor plane. The position sensor may be or may include an optical encoder.

Next, the computer program, the computer-readable data carrier and the control device are specified.

According to an embodiment, the computer program includes instructions which, when the program is executed by a computer, cause the computer to carry out the method for operating a wind turbine according to any one of the embodiments described herein.

According to an embodiment, the computer-readable data carrier has the computer program stored thereon.

According to an embodiment, the control device includes at least one processor and/or at least one programmable logic controller, plc for short, configured to perform the method for operating a wind turbine according to any one of the embodiments described herein. The control device may be a computer, for example. The control device may be part of the wind turbine or may be an external device, which is, for example, several km away from the wind turbine, like a computer in a control station (remote control). For example, the control device is configured to communicate with the wind turbine or components thereof via a wire or wirelessly.

Next, the control system for operating a wind turbine is specified. The control system is, in particular, configured to perform the method according to any one of the embodiments described herein. Therefore, all features disclosed for the method are also disclosed for the control system and vice versa.

According to an embodiment, the control system is a control system for operating a wind turbine which has a rotor with N rotor blades, wherein N≥2, and a pitch setting system for individually setting the pitch angles of the N rotor blades. The control system includes a sensor system configured to take measurements with the help of which it is determinable whether an edge-wise movement of at least one rotor blade exceeds a threshold while the rotor is rotating with frequency P. The control system further includes the control device as specified herein. The control device is signally connectable or connected to the sensor system in order to provide the control device with the measurements of the sensor system. The control device is signally connectable or connected to the pitch setting system in order to provide the pitch setting system with the output signal of the control device so that the pitch setting system sets the pitch angles of the rotor blades depending on the output signal.

For example, the sensor system is signally connectable or is signally connected with the control device via a wire or wirelessly. The sensor system and/or the control device may be part of the wind turbine, that is, may be integrated into the wind turbine, or may be external. The control device may be signally connected or connectable to the pitch setting system via wire or wirelessly.

The control device may, accordingly, include an interface for receiving data from the sensor system and an interface for sending the output signal to the pitch setting system.

The pitch setting system may be part of the control system. The pitch setting system includes, for example, at least one actuator for each of the rotor blades, wherein the actuator is configured to change and/or set the pitch angle of the respective rotor blade. The pitch setting system is configured to individually and periodically change the pitch angles of the rotor blades. For example, it is configured to change the pitch angles of the rotor blades independently of each other.

According to a further embodiment, the sensor system includes at least one strain sensor for each rotor blade. For example, each rotor blade is assigned at least one strain sensor coupled thereto. For example, each rotor blade is assigned at least three or at least four strain sensors. Strain sensors allow the bending moment(s) acting on the rotor blade to be determined. All features disclosed for the at least one strain sensor are herein also disclosed for all other strain sensors.

The strain sensors may be integrated into the respective rotor blade or may be applied to an outer surface of the respective rotor blade. The strain sensors may be temperature compensating strain sensors.

According to a further embodiment, the strain sensors are fiber optic strain sensors.

According to a further embodiment, the strain sensors are strain gauge sensors.

Next, the wind turbine is specified.

According to an embodiment, the wind turbine includes a rotor with N rotor blades, wherein N≥2, and a pitch setting system for individually setting the pitch angles of the N rotor blades. Furthermore, the wind turbine includes the control system according to any one of the embodiments described herein.

### BRIEF DESCRIPTION OF DRAWINGS

The invention will now be described with reference to the drawings wherein:

FIG. 1 shows an embodiment of a wind turbine;

FIGS. 2 and 3 show the behavior of an embodiment of the wind turbine during operation at different conditions;

FIG. 4 shows an example of the time-dependent tilt bending moment acting on the rotor of a wind turbine;

FIG. 5 shows a graph illustrating different frequencies being of relevance in a wind turbine;

FIGS. 6 and 7 show examples of the time-dependent edge-wise bending-moment acting on a rotor blade of a wind turbine;

FIGS. 8 to 10 show flowcharts of different embodiments of the method for operating a wind turbine;

FIG. 11 shows an embodiment of the control system and the control device; and,

FIG. 12 shows a further embodiment of the method for operating a wind turbine.

### DETAILED DESCRIPTION

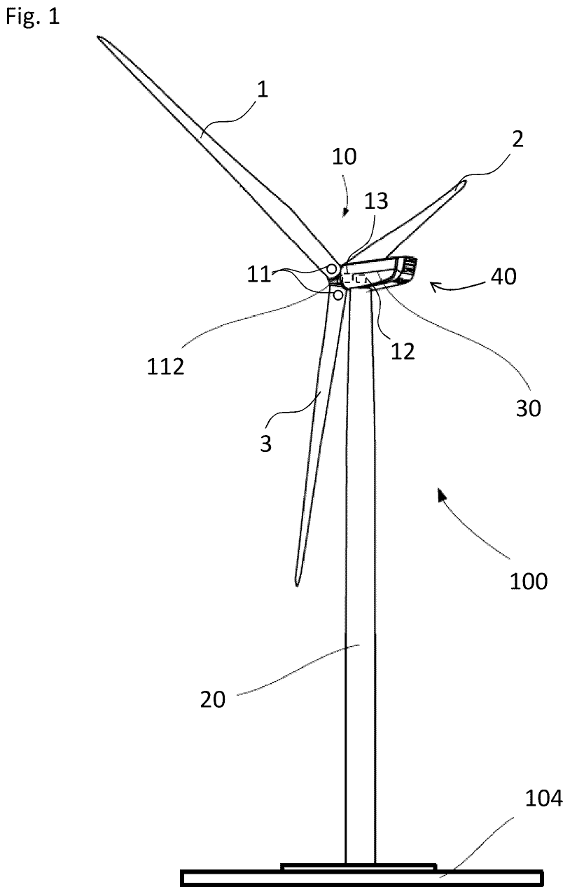

FIG. 1 shows a schematic view of an embodiment of a wind turbine 100 which includes a tower 20. The tower 20 is fixed to the ground via a foundation 104. At one end of the tower 20, opposite to the ground, a nacelle 106 is rotatably mounted. The nacelle 106, for example, includes a generator which is coupled to a rotor 10 via a gearbox (not shown). The rotor 10 includes N=3 (wind turbine) rotor blades 1, 2, 3, which are arranged on a rotor hub 112, the rotor hub 112 being connected to a rotor shaft (not shown).

During operation, the rotor 10 is set in rotation by an air flow, for example wind. This rotational movement is transmitted to the generator via the rotor shaft and the gearbox. The generator converts the mechanical energy of the rotor 10 into electrical energy.

In order to control the rotational speed and the power output, the wind turbine 100 includes a pitch setting system 13 which is configured to set the pitch angles of the rotor blades 1, 2, 3. The pitch setting system 13 is configured to set the pitch angle of each rotor blade 1, 2, 3 individually and periodically. For example, the pitch setting system 13 includes at least one actuator for each rotor blade 1, 2, 3 via which an electrical signal is translated into a mechanical movement of the respective rotor blade 1, 2, 3 about its longitudinal axis.

The wind turbine 100 further includes a control system 40 configured to operate the wind turbine 100. The control system 40 includes a first sensor system 11, a second sensor system 12 and a control device 30.

The first sensor system 11 includes, for example, three or four strain sensors for each rotor blade 1, 2, 3, wherein the strain sensors are coupled to the respective rotor blade 1, 2, 3. The strain sensors may be fiber optic strain sensors, for example. The measurement signals from the strain sensors may be used to estimate/determine the bending moment acting on the respective rotor blade 1, 2, 3. Furthermore, the first sensor system 11 may include at least one position sensor with the help of which the positions of the rotor blades 1, 2, 3, that is, their azimuthal angles, can be determined.

The second sensor system 12 includes, for example, at least one sensor for measuring the pitch angles of the rotor blades 1, 2, 3, at least one sensor for measuring the rotational speed of the rotor 10 and at least one sensor for measuring the power output of the wind turbine. The measurement signals of these sensors can be used to estimate/determine the thrust force acting on the rotor 10 and the wind turbulence intensity at the rotor 10.

The control device 30 includes, for example, at least one processor. It may be located in the nacelle 106. The control device 30 is signally coupled to the sensor systems 11, 12 and the pitch setting system 13 so that it can communicate with the systems 11, 12, 13. The measurements from the sensor systems 11, 12 are processed by the control device 30 and, depending on this, an output signal is possibly transmitted to the pitch setting system 13 in order to adjust the pitch angles of the rotor blades 1, 2, 3.

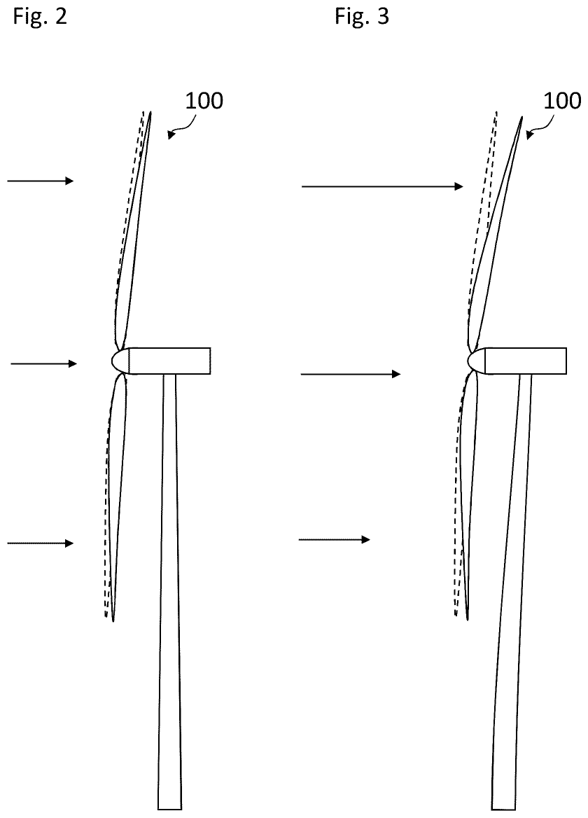

FIG. 2 shows the wind turbine 100 from a side view during operation of the wind turbine 100. Wind acting on the rotor 10 of the wind turbine 100 is indicated by the arrows. In FIG. 2, the wind speed is constant all over the rotor 10. Due to the forces acting on the rotor blades, the rotor blades are deflected with respect to their rest positions (the rest positions are indicated by the dashed lines). As a consequence, tilt bending moments and yaw bending moments act on the rotor in order to deflect or tilt the rotor plane, respectively.

In FIG. 3, an overall higher wind speed acts on the rotor 10. Furthermore, the wind speed is lower closer to the ground than further away from the ground (so-called wind shear). As can be seen, the deflection of the rotor blades is now larger compared to FIG. 2. Moreover, due to the greater thrust force acting on the rotor, the tower is bended.

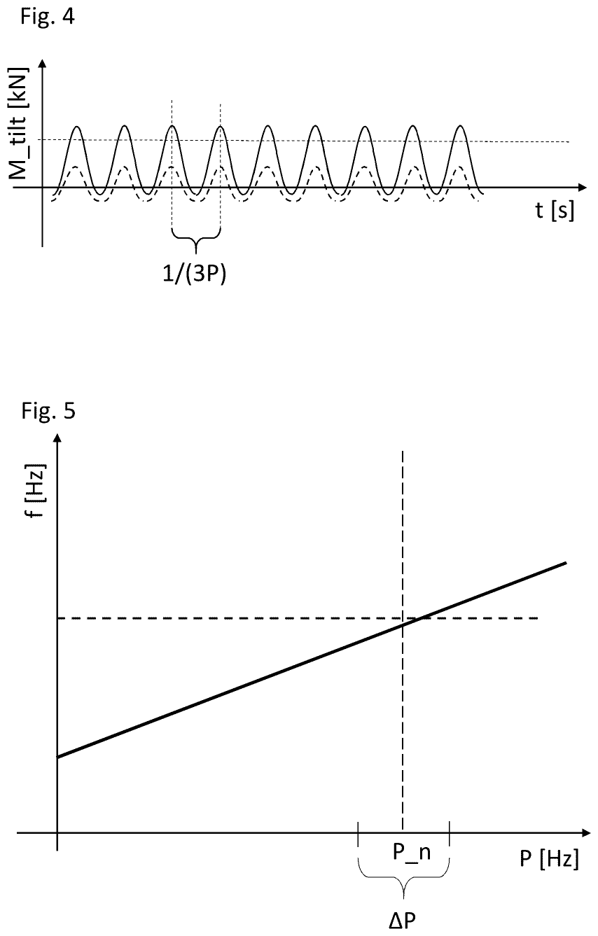

Since, during operation of the wind turbine 100, the rotor 10 is rotating, the tilt bending moments and the yaw bending moments acting on the rotor 10 oscillate. This can be seen in FIG. 4, showing the tilt bending moment M_tilt acting on the rotor 10 while the rotor is rotating with frequency P as a function of time t. The dashed curve shows the case of the lower overall wind speed and constant wind speed, as illustrated in connection with FIG. 2, and the solid line shows the case of the higher overall wind speed and wind shear, as illustrated in connection with FIG. 3. As can be seen, the tilt bending moment M_tilt indeed oscillates with frequency 3*P.

The tilt bending moment M_tilt as shown in FIG. 4 may be determined, for example, from measurements taken with the first sensor system 11 and with the help of a coordinate transformation from the rotating reference frame into the fixed reference frame of, for example, the nacelle 106.

FIG. 5 shows a graph with the frequency P with which the rotor 10 is rotating on the x-axis and the frequency of edge-wise vibrations of the rotor blades on the y-axis. The horizontal dashed line indicates the first Eigen-frequency of the edge-wise vibrations of the rotor blades. The first Eigen-frequency changes only very little with increasing frequency P (not visible in FIG. 5). The solid line in FIG. 5 is the frequency (M*N+1)*P, with N being the number of rotor blades of the wind turbine and M being an integer greater than zero. For the present case, N=3 and M=1, thus the solid line shows the frequency 4*P.

As can be seen, the frequency 4*P intersects with the first Eigen-frequency of the edge-wise vibration of the rotor blades at a certain point. The vertical dashed line indicates the nominal rotational speed of the rotor or the nominal frequency P_n of the rotor, respectively. This nominal frequency is very close to the point where the first Eigen-frequency and the frequency 4*P intersect. Thus, when the rotor is rotating with a frequency P close to the nominal frequency P_n, an excitation of the edge-wise vibration with frequency 4*P would be resonant.

On the other hand, the frequency 4*P in the rotating reference frame corresponds to the frequency 3*P in the fixed reference frame. Consequently, a periodic force acting on the rotor 10 with the frequency 3*P can resonantly excite the edge-wise vibrations of the rotor blades 1, 2, 3 at their first Eigen-frequencies when the rotor 10 is rotating with a frequency P close to the nominal frequency P_n. Such a large periodic force acting on the rotor 10 with frequency 3*P appears, however, for example due to a wind shear or local gust as explained in connection with FIGS. 2 to 4.

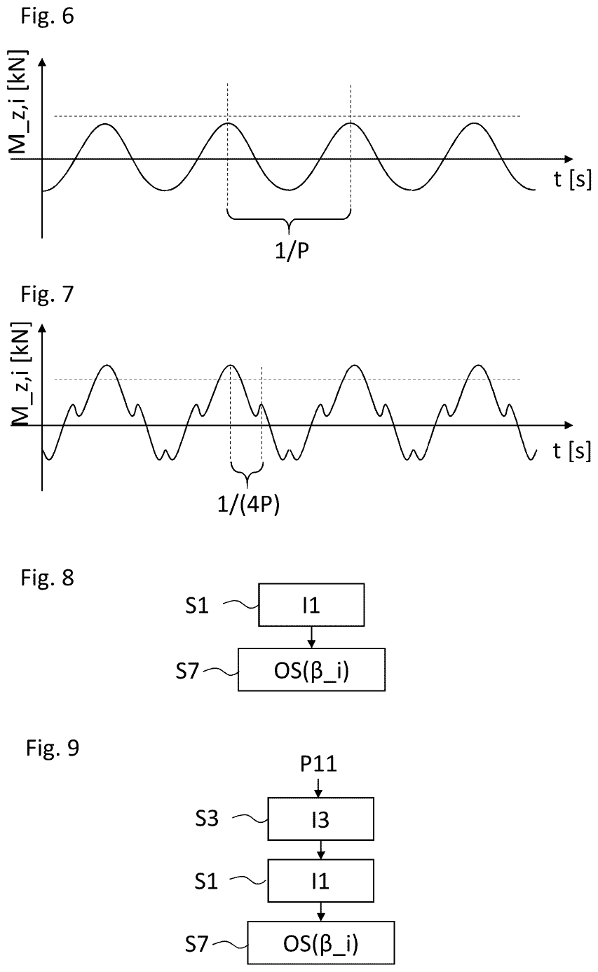

FIGS. 6 and 7 illustrate measurements of edge-wise bending moments M_z,i of a rotor blade as a function of time t. FIG. 6 shows the case without an excitation of the first edge-wise Eigen-frequency and FIG. 7 shows the case with an excitation of the first edge-wise Eigen-frequency.

In FIG. 6, a periodic change of the edge-wise bending moment acting on the rotor blade with frequency P is visible. This P-content, that is, content with frequency P, in the edge-wise bending moment results, for example, from the gravitational force acting on the rotor blade during rotation of the rotor with frequency P.

In FIG. 7, there is an additional 4*P-content, that is, a content with frequency 4*P. The 4*P-content results, as explained above, from wind shear or local gust acting on the rotor. The 4*P content is considerably large since it is resonantly excited (when P is close to the nominal frequency). Thus, the maximum amplitude of the edge-wise vibration is considerably increased in FIG. 7 compared to FIG. 6.

Since wind shear or local gust appear very often during operation of a wind turbine, large edge-wise vibrations of the rotor blades as indicated in FIG. 7 appear frequently. However, such edge-wise vibrations induce high load on the rotor shaft and can also damage the rotor blades themselves. The vibrations could be reduced by reducing the rotational speed away from the nominal frequency P_n or by a shutdown of the wind turbine. This reduces the annular energy production.

The inventors of the present disclosure developed a method for operating a wind turbine which allows the edge-wise vibrations of the rotor blades to be reduced without the need to change the rotational speed of the rotor or shutting down the wind turbine.

FIG. 8 shows a first embodiment of this method for operating a wind turbine. In a step S1, a first information I1 is determined which is representative for whether an edge-wise movement of at least one rotor blade 1, 2, 3 exceeds a threshold while the rotor is rotating with frequency P. If the first information I1 is representative for the edge-wise movement of at least one rotor blade to exceed the threshold, a step S7 is executed in which an output signal OS is generated. The output signal OS is configured to cause the pitch setting system 13 to individually and periodically change the pitch angles β_i of the rotor blades 1, 2, 3 each with a frequency of (M*N−1)*P in order to reduce the edge-wise movement of the at least one rotor blade. The index “i” herein stands for the different rotor blades and can be 1, 2 or 3 in the present case of three rotor blades.

As before, M=1 and N=3, so (M*N−1)*P=2*P. This means that for each rotor blade 1, 2, 3, the pitch angle β_i is periodically changed with the frequency 2*P. With such a periodic change in the pitch angles β_i, the excitation of the first edge-wise Eigen-frequency can indeed be counteracted.

For example, for each rotor blade 1, 2, 3, when the rotor blade is at the point of the highest wind speed, the pitch angle β_i is chosen such that the thrust force acting on the rotor blade is reduced (large pitch angle) and when the rotor blade is at the point opposite of the location of the highest wind speed, the pitch angle β_i of the rotor blade is chosen such that the thrust force acting on the rotor blade is increased (small pitch angle). In this way, the 3*P-content in the tilt-bending moment M_tilt is reduced and consequently the excitation of the first Eigen-frequency of the edge-wise vibration is less prominent. For example, the pitch angle β_i of each rotor blade 1, 2, 3 may be changed by at least 1° or at least 2° or at least 3° during the periodic change.

FIG. 9 shows a second embodiment of the method in which a step S3 is executed before step S1. In step S3, third information I3 is provided which is representative for the bending moments M_y,i, M_z,i acting on the rotor blades 1, 2, 3. The bending moments are the edge-wise bending moments M_z,i, as for example shown in FIGS. 6 and 7, and the flap-wise bending moments M_y,i of the rotor blades. The third information I3 is determined with the help of the measurements P11 taken with the first sensor system 11.

The first information I1 is then determined depending on the third information 13. For example, it is determined whether an amplitude of the edge-wise bending moment M_z,i of at least one rotor blade 1, 2, 3 exceeds a threshold (see horizontal dashed line in FIGS. 6 and 7). If it is determined that the edge-wise bending moment M_z,i exceeds the threshold, the first information I1 is determined to be representative for the edge-wise movement of the respective rotor blade to exceed the threshold and, accordingly, the output signal OS is generated.

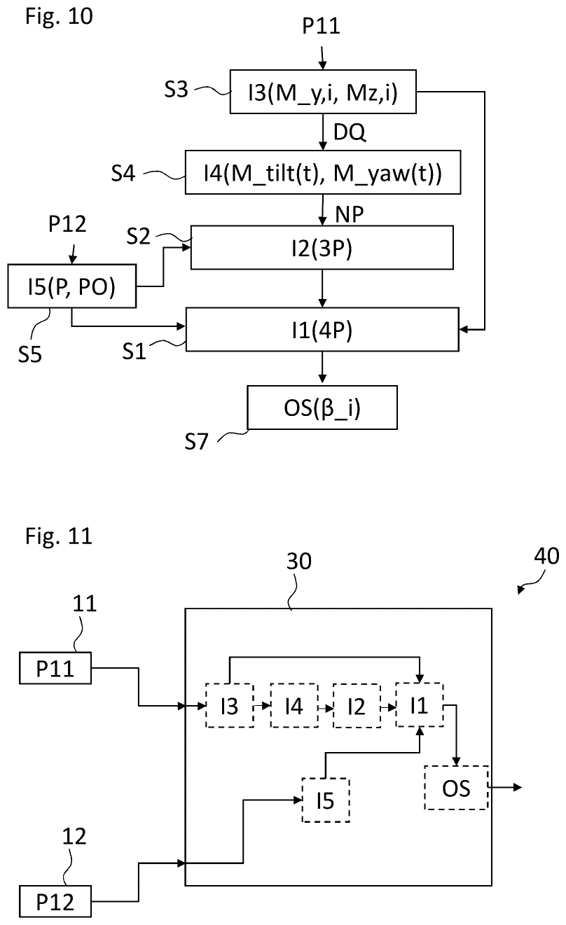

In the embodiment of FIG. 10, measurements P11 from the first sensor system 11 are provided. These measurements P11 are used to determine the third information 13. Afterwards, a fourth information I4 is determined depending on the third information I3. The third information I4 is representative for a bending moment, for example the tilt bending moment M_tilt and/or the yaw bending moment M_yaw, acting on the rotor 10. These bending moments M_tilt, M_yaw can be determined from the bending moments M_y,i, M_z,i acting one the rotor blades 1, 2, 3 by using a coordinate transformation DQ, for example, a Coleman transformation. The fourth information I4 is, for example, what is shown in connection with FIG. 4.

The fourth information I4 is then used to determine a second information I2 (step S2). The second information I2 is representative for the M*N*P-content, that is, the 3*P-content for the present case, in the bending moment(s) M_tilt, M_yaw. This 3*P content can be extracted by using a band-pass filter and/or a notch filter, for example.

Additionally, the method includes a step S5 in which fifth information I5 is provided (step S5). The fifth information I5 is representative for the rotational speed of the rotor, that is, the frequency P, and/or the power output PO of the wind turbine. The fifth information I5 is, for example, determined depending on the measurements P12 taken with the help of the second sensor system 12.

The first information I1 being representative for whether the edge-wise movement of at least one rotor blade exceeds the threshold is then determined depending on the second information I2, depending on the third information I3 and depending on the fifth information I5. For example, with the help of the second information I2 it is determined whether an amplitude of the 3*P-content in a bending moment M_tilt, M_yaw exceeds a threshold (see, for example, horizontal dashed line in FIG. 4). With the help of the third information I3, it may be determined whether an amplitude of the edge-wise bending moment M_z,i of at least one rotor blade 1, 2, 3 exceeds a threshold (see horizontal dashed line in FIGS. 6 and 7). With the help of the fifth information I5, it may be determined whether the frequency P with which the rotor 10 is rotating lies in a critical frequency range ΔP (see range indicated in FIG. 5) and/or whether the power output PO lies in a critical power range. Only if at least two of the mentioned conditions are fulfilled, is the first information I1 determined to be representative for the edge-wise movement of at least one rotor blade 1, 2, 3 to exceed the threshold and, accordingly, the output signal OS is generated.

FIG. 11 shows an embodiment of the control system 40. The control system 40 includes the sensor systems 11, 12, with which the measurements P11, P12 can be taken. These measurements P11, P12 are provided to the control device 30 which performs the method steps as described in connection with FIGS. 8 to 10 and delivers an output signal OS, which the control system 40 then transmits to the pitch setting system 13 of the wind turbine 100 in order to adjust the pitch angles.

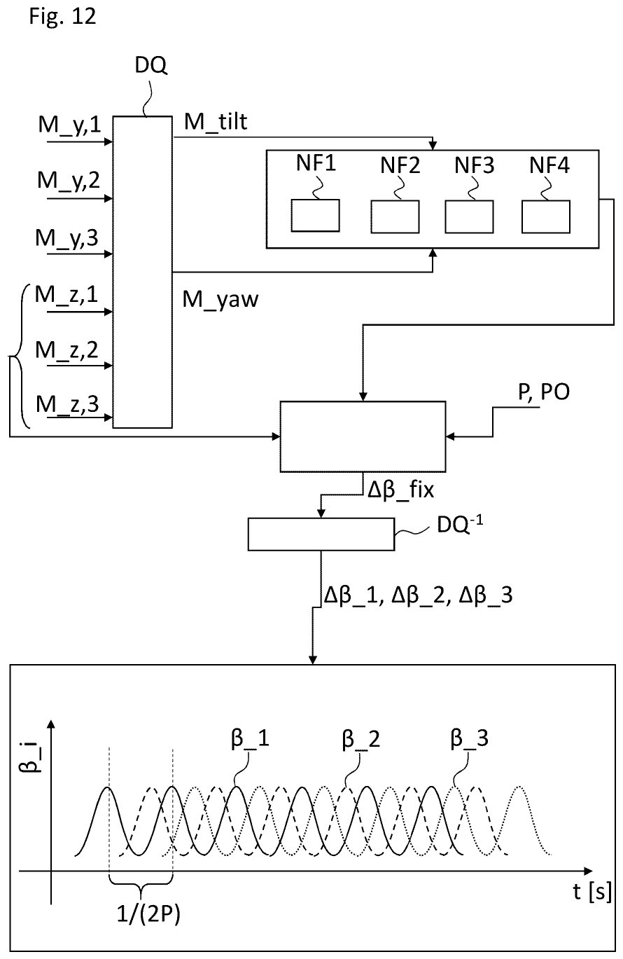

FIG. 12 shows a further embodiment of the method indicating the different calculations done when performing the method. Bending moments M_y,i, M_z,i acting on the rotor blades 1, 2, 3, which may have been determined depending on the measurements P11 obtained from the first sensor system 11, are used as an input for a coordinate transformation DQ, for example, a Coleman transformation DQ, in order to transform from the rotating reference frame into the fixed reference frame. The coordinate transformation DQ delivers the bending moments M_tilt, M_yaw acting on the rotor 10. Filters NF1, NF2, NF3, NF4 are applied to the bending moments M_tilt, M_yaw in order to extract different contents in the bending moments M_tilt, M_yaw. The filters may be band-pass filters. For example, the filter NF1 extracts the 3*P-content, the filter NF2 extracts the 6*P-content, the filter NF3 extracts the 9*P-content and so on.

The results of the filters together with the information about the edge-wise bending moments M_z,i and the information about the frequency P with which the rotor 10 rotates and/or the power output PO are then used to determine the first information I1. A quantity Δβ_fix is calculated in the case that the first information I1 is representative for the edge-wise movement of at least one rotor blade 1, 2, 3 to exceed the threshold. An inverse coordinate transformation DQ⁻¹ is applied to this quantity in order to transform from the fixed reference frame back into the rotating reference frame. The output of this are individual and periodic changes Δβ_1, Δβ_2, Δβ_3 of the pitch angles β_i of the different rotor blades 1, 2, 3. This information is then stored in the output signal OS and transferred to the pitch setting system 13.

The pitch angles β_i as a function of time t as determined with the above-described method are illustrated in the lower part of FIG. 12. The pitch angles β_i oscillate with the frequency 2*P and the curves are phase-shifted with respect to one another.

It is understood that the foregoing description is that of the preferred embodiments of the invention and that various changes and modifications may be made thereto without departing from the spirit and scope of the invention as defined in the appended claims.

### REFERENCE SIGNS

1 first rotor blade
2 second rotor blade
3 third rotor blade
10 rotor
11 first sensor system
12 second sensor system
13 pitch control system
20 tower
30 control device
40 control system
100 wind turbine
104 foundation
106 nacelle
112 rotor hub
I1 first information
I2 second information
I3 third information
I4 fourth information
I5 fifth information
OS output signal
M_z,i edge-wise bending moment
M_y,l flap-wise bending moment
M_tilt tilt bending moment
M_tilt yaw wending moment
β_i pitch angle
Δβ_i pitch angle change
Δβ_fix pitch angle change in fixed reference frame
P11 measurements
P12 measurements
P frequency
P_n nominal frequency
PO power output
ΔP frequency range
DQ coordinate transformation
DQ⁻¹ inverse coordinate transformation
NF1 first filter
NF2 second filter
NF3 third filter
NF4 fourth filter
S1 to S7 method steps

1-16. (canceled)

17. A method for operating a wind turbine having a rotor with N rotor blades, wherein N≥2, and a pitch setting system for individually setting the pitch angles of the N rotor blades, the method comprising:
determining first information which is representative for whether an edge-wise movement of at least one rotor blade exceeds a threshold while the rotor is rotating with a frequency P; and,
if the edge-wise movement of the at least one rotor blade exceeds the threshold while the rotor is rotating with the frequency P, generating an output signal configured to cause the pitch setting system to individually and periodically change the pitch angles of the N rotor blades each with a frequency of (M*N−1)*P in order to reduce edge-wise movements of the rotor blades, wherein M is an integer greater than 0.

18. The method of claim 17 further comprising:
providing second information representative for an M*N*P-content in a bending moment (M_tilt, M_yaw) acting on the rotor while the rotor is rotating with the frequency P, wherein the M*N*P-content is the content in the bending moment (M_tilt, M_yaw) having the frequency M*N*P, and, wherein the first information is determined depending on the second information.

19. The method of claim 17, wherein:
$$N = 3 , and \\ M = 1.$$

20. The method of claim 18 further comprising:
providing third information which is representative for bending moments (M_y, i, M_z, i) acting on the at least one rotor blade; and,
wherein the first information is determined depending on the third information.

21. The method according to claim 18 further comprising:
providing fourth information representative for the bending moment (M_tilt, M_yaw) acting on the rotor as a function of time, wherein the second information is determined depending on the fourth information via a filter.

22. The method of claim 20, further comprising:
providing fourth information representative for a bending moment (M_tilt, M_yaw) acting on the rotor as a function of time, wherein the second information is determined depending on the fourth information via a filter and the fourth information is determined depending on the third information using a coordinate transformation.

23. The method of claim 18, wherein said determining the first information includes determining whether an amplitude of the M*N*P-content exceeds a threshold.

24. The method of claim 20, wherein:
the third information is representative for the respective edge-wise bending moment (M_z, i) acting on the at least one rotor blade; and,
the first information is determined depending on the third information and includes determining whether the amplitude of the edge-wise bending moment (M_z, i) acting on at the least one rotor blade exceeds the threshold.

25. The method of claim 24, wherein:
said determining the first information includes determining whether a (M*N+1)*P-content in the edge-wise bending moment (M_z, i) acting on the at least one rotor blade exceeds a bending moment threshold, wherein:
the (M*N+1)*P-content is the content in the edge-wise bending moment (M_z, i) having the frequency (M*N+1)*P.

26. The method of claim 17, wherein said determining the first information includes determining at least one of whether the frequency P lies within a critical frequency range and whether a power output of the wind turbine lies within a critical power range.

27. The method of claim 20, wherein the third information is determined depending on measurements taken via a sensor system.

28. A computer program comprising instructions which, when the program is executed by a computer, cause the computer to carry out the method of claim 17.

29. A non-transitory computer-readable data carrier having the computer program of claim 28 stored thereon.

30. A control device comprising at least one processor configured to perform the method of claim 17.

31. A control system for operating a wind turbine having a rotor with N rotor blades, wherein N≥2, and a pitch setting system for individually setting the pitch angles of the N rotor blades, the control system comprising:
a sensor system configured to take measurements via which it is determinable whether an edge-wise movement of at least one rotor blade exceeds a threshold while the rotor is rotating with frequency P;
a control device including at least one processor and a non-transitory computer readable medium having program code stored thereon, wherein said program code is configured, when executed by said processor, to:
determine first information which is representative for whether an edge-wise movement of at least one rotor blade exceeds the threshold while the rotor is rotating with the frequency P; and,
if the edge-wise movement of at least one rotor blade exceeds the threshold while the rotor is rotating with the frequency P, generate an output signal configured to cause the pitch setting system to individually and periodically change the pitch angles of the N rotor blades each with a frequency of (M*N−1)*P in order to reduce the edge-wise movements of the at least one rotor blade, wherein M is an integer greater than 0;
said control device being signally connectable to said sensor system in order to provide said control device with the measurements of the sensor system; and,
said control device being signally connectable to the pitch setting system in order to provide the pitch setting system with said output signal of said control device so that the pitch setting system sets the pitch angles of the rotor blades depending on said output signal.

32. A wind turbine comprising:
a rotor with N rotor blades, wherein N≥2;
a pitch setting system for individually setting pitch angles of said N rotor blades;
a control system including a sensor system configured to take measurements via which it is determinable whether an edge-wise movement of at least one rotor blade exceeds a threshold while said rotor is rotating with frequency P;
said control system further including a control device having at least one processor and a non-transitory computer readable medium having program code stored thereon, wherein said program code is configured, when executed by said processor, to:
determine first information which is representative for whether an edge-wise movement of at least one rotor blade exceeds the threshold while said rotor is rotating with the frequency P; and,
if the edge-wise movement of the at least one rotor blade exceeds the threshold while said rotor is rotating with the frequency P, generate an output signal configured to cause said pitch setting system to individually and periodically change the pitch angles of said N rotor blades each with a frequency of (M*N−1)*P in order to reduce edge-wise movements of said at least one rotor blade, wherein M is an integer greater than 0;
said control device being signally connectable to said sensor system in order to provide said control device with the measurements of said sensor system; and,
said control device being signally connectable to said pitch setting system in order to provide said pitch setting system with said output signal of said control device so that said pitch setting system sets the pitch angles of said at least rotor blade depending on said output signal.
